(19) United States
(12) Patent Application Publication
(10) Pub. No.: US 2016/0244307 A1
(43) Pub. Date: Aug. 25, 2016

(54) MODULAR JACKING SYSTEMS AND METHODS

(71) Applicant: Richard W. Bogert, Kennewick, WA (US)

(72) Inventor: Richard W. Bogert, Kennewick, WA (US)

(21) Appl. No.: 15/047,471

(22) Filed: Feb. 18, 2016

Related U.S. Application Data
(60) Provisional application No. 62/118,372, filed on Feb. 19, 2015.

(51) Int. Cl. B66F 3/36; B66F 3/24

(52) U.S. Cl. CPC B66F 3/36; B66F 3/24

(57) ABSTRACT

A jacking system adapted to facilitate jacking of a lifting structure includes an extension system which is interchangeably coupleable to a jacking device or a jack stand. The extension system can include a coupler portion having an opening which is configured to removably couple the coupler portion to the jacking device or the jack stand and a ram portion which is configured to be engagingly coupleable to the lifting structure. Related methods of lifting and supporting a lifting structure are also provided.

### BACKGROUND

1. Technical Field

The present disclosure relates to jacking systems and, more particularly, to modular jacking systems having extension systems that can be interchangeably used for a wide variety of applications.

2. Description of the Related Art

Each year tens of thousands of people are injured due to jacking related accidents. Various studies and reports have posited that many of such accidents may be attributed to unstable vehicles or jacking systems that may cause the vehicle or load to slip off a jacking device. Solutions to mitigate instability of jacking devices often require additional jack stands, which are bulky, heavy, and integral or one-piece devices.

However, such solutions suffer from a multitude of deficiencies. For instance, the large volume of space occupied by such bulky jack stands reduces its utility, in that they occupy a large footprint of available storage space in vehicles. Further, such jacking stands have a limited vertical range. Consequently, after lifting a vehicle, for example with a jacking device, the jack stands are often placed on blocks or other structures to match a vertical lifting height of the jacking device. Such blocks or other structures are often unavailable. Still further, in many instances, the vertical lifting height or stroke of the jacking device is difficult to precisely match when jack stands are positioned by using blocks, rocks, etc.

### BRIEF SUMMARY

Embodiments described herein provide jacking systems and methods to lift vehicles in compact, robust, efficient form factors. For example, according to one embodiment, a jacking system adapted to facilitate jacking of a lifting structure can be summarized as including an extension system interchangeably coupleable to a jacking device and/or a jack stand. The extension system can include a coupler portion having an opening, the opening configured to removably couple the coupler portion to the jacking device and/or the jack stand; and a ram portion configured to be engagingly coupleable to the lifting structure.

According to another embodiment, a method to facilitate lifting of a lifting structure can be summarized as including coupling an extension system to a jacking device and/or a jack stand, such that the extension system is configured to interchangeably lift the lifting structure and/or support the lifting structure.

### BRIEF DESCRIPTION OF THE SEVERAL VIEWS OF THE DRAWINGS

FIG. 1 is a partially exploded perspective view of a jacking system, according to one embodiment.

FIG. 2 is a partially exploded perspective view of a jacking support system, according to another embodiment.

FIGS. 3A-3D are perspective views of jack pads according to various exemplary embodiments.

FIG. 4 is a perspective view of a jacking system, according to another embodiment.

FIG. 5 is a partially exploded perspective view of an extension system, according to another embodiment.

### DETAILED DESCRIPTION

It will be appreciated that, although specific embodiments of the subject matter of this application have been described herein for purposes of illustration, various modifications may be made without departing from the spirit and scope of the disclosed subject matter. Accordingly, the subject matter of this application is not limited except as by the appended claims.

In the following description, certain specific details are set forth in order to provide a thorough understanding of various aspects of the disclosed subject matter. However, the disclosed subject matter may be practiced without these specific details. In some instances, well-known structures and methods of attaching structures to each other comprising embodiments of the subject matter disclosed herein have not been described in detail to avoid obscuring the descriptions of other aspects of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

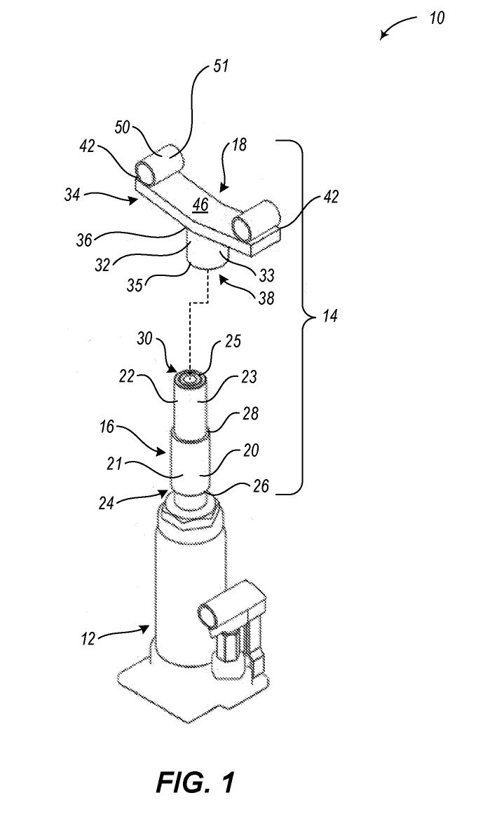

FIG. 1 illustrates a jacking system 10 according to one example embodiment. The jacking system 10 includes a jacking device 12 and an extension system 14 removably coupled to the jacking device 12. While the jacking device 12 illustrated in FIG. 1 is a hydraulic jack, e.g., a bottle jack, other jacking devices are within the scope and spirit of the disclosed subject matter.

The extension system 14 includes a ram extension 16 and a jack pad 18. The ram extension 16 includes a coupler portion 20 and a ram portion 22. The coupler portion 20 has a generally annular body 21 having a first end 26 and a second end 28. At its first end 26, the body 21 of the coupler portion 20 has an opening 24 to define an inner diameter of the coupler portion 20. The opening 24 is configured such that a piston of the jacking device 12 is removably received in the coupler portion 20. By way of example, the inner diameter of the body 21 of the coupler portion 20 is sized and shaped to be larger than an outer diameter of the piston of the jacking device 12 such that, when the piston is received in the coupler portion 20, the coupler portion 20 encloses a portion of the piston of the jacking device 12.

The ram portion 22 extends from the second end 28 of the coupler portion 20. The ram portion 22 has a substantially cylindrical body 23. At its distal end, the ram portion 22 includes a plurality of concentric rings 25 to define an engaging surface 30. The rings 25 are configured to facilitate gripping when the engaging surface 30 abuts or makes contact with a lifting structure, such as a vehicle, for example. By way of example, according to some aspects, the ram portion 22 may be adapted to directly engage the lifting structure, without other intervening structures, as discussed in more detail below. While the embodiment illustrated in FIG. 1 includes rings 25 to define the engaging surface 30, in other embodiments, the engaging surface 30 may include a waffle pattern, or other textured pattern to facilitate gripping, as discussed above.

In some embodiments, the ram extension 16 can be monolithically formed, comprising an integral or unitary body. For example, the ram extension 16 can be formed using a machining process, extrusion process, molding process (e.g., injection molding processes), vacuum forming (e.g., vacuum bag molding), combinations thereof, and the like. However, it is appreciated that embodiments of the ram extension 16 comprising separate components coupled together are also within the spirit and scope of the disclosed subject matter. By way of example, in some embodiments the coupling portion 20 may be coupled to the ram portion 22 using various techniques, such as welding, fastening, adhering, etc.

The body 23 of the ram portion 22 has an outer diameter that is sized and shaped to be less than the outer diameter of the body 21 of the coupler portion 20. More particularly, the outer diameter of the body 23 of the ram portion 22 is sized and shaped to be removably received in the jack pad 18. The jack pad 18 includes a receiving portion 32 and an engaging portion 34. The receiving portion 32 has a generally annular body 33 with a first end 35 and a second end 36. At its first end 35, the receiving portion 32 includes an opening 38 to define an inner diameter of body 23 of the receiving portion 32. The opening 38 is configured such that the ram portion 22 of the ram extension 16 is removably received in the jack pad 18. By way of example, the inner diameter of the body 23 of the receiving portion 32 is sized and shaped to be larger than the outer diameter of the ram portion 22 of the ram extension 16 such that when the ram extension 16 is received in the jack pad 18, the receiving portion 32 encloses a portion of the ram portion 22 of the ram extension 16.

The engaging portion 34 extends laterally from the second end 36 of the receiving portion 32 in a substantially symmetrical manner about a central axis of the receiving portion 32 to define two opposing ends 42. The engaging portion 34 is formed from a plate type structure. In particular, the engaging portion 34 extends angularly with respect to an imaginary horizontal plane lying at a lower surface of the body 33 of the receiving portion 32 to define a V-shaped engaging portion 34. The horizontal plane is substantially perpendicular to the central axis of the receiving portion 32. In some embodiments, the engaging portion 34 may extend angularly with respect to the horizontal plane at an angular range of 0 to 45 degrees.

An upper surface of the engaging portion 34 defines an engaging surface 46. The engaging surface 46 is configured to abut or make contact with a corresponding surface of the lifting structure. More particularly, the engaging portion 34 is configured to advantageously engage a wide variety of components of the lifting structure, such as a frame, axle, etc., by increasing the contact surface area. Additionally, the downward gravitational forces applied to the lifting structure due to the positive angular positioning of the engaging portion 34 with respect to the horizontal plane inhibits or reduces the lateral movement of the lifting structure, thus reducing, mitigating, or avoiding slipping of the lifting structure.

At each of the opposing ends 42, the engaging portion 34 includes a pair of stops 50. The stops 50 have an annular body 51 and are advantageously located to reduce, mitigate, or avoid lateral movement of the lifting structure when the engaging portion 34 engages the lifting structure. In this manner, slipping of the lifting structure can be further reduced, mitigated, or inhibited. By way of example, outer surfaces of the bodies 51 of the stops 50 can abut or make substantial contact with the lifting structure during any lateral movement to reduce, mitigate, or inhibit slipping. Further, the stops 50 can also facilitate supporting loads, such as from the lifting structure, which may be cylindrical or round-shaped. Still further, the stops 50 can also facilitate supporting loads which may be larger than loads that can be interposed between the stops 50. For example, the lifting structure may be positioned to abut or make contact with the outer surfaces of the bodies 51 of the stops 50.

The jack pad 18 in some embodiments can be monolithically formed, comprising an integral or unitary body. For example, the jack pad 18 can be formed using a machining process, extrusion process, molding process (e.g., injection molding processes), vacuum forming (e.g., vacuum bag molding), combinations thereof, and the like. However, it is appreciated that embodiments of the jack pad 18 comprising separate components coupled together are also within the spirit and scope of the disclosed subject matter. By way of example, in some embodiments the receiving portion 32, stops 50, and engaging portion 34 may be coupled together using various techniques, such as welding, fastening, adhering, etc.

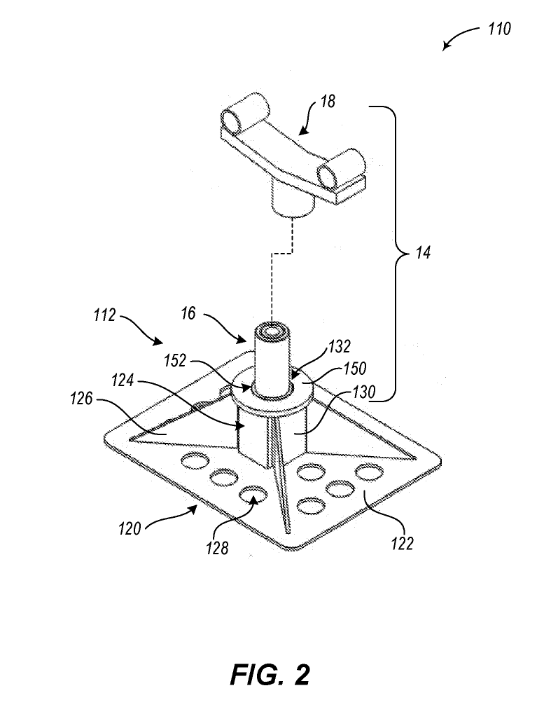

FIG. 2 illustrates a jacking support system 110 according to one embodiment. The jacking support system 110 includes the extension system 14 removably received in a base member 120. The extension system 14 thus can also be used advantageously to construct a jack stand 112.

The base member 120 includes a base plate 122, a receiver member 124 and a plurality of gussets 126. The base plate 122 is substantially rectangular shaped and includes a plurality of apertures 128. The plurality of apertures 128 advantageously facilitates reduction of weight and ease of handling. By way of example, a user can lift the base member 120 by inserting fingers through the apertures 128. Further, the plurality of apertures 128 can also advantageously assist in gripping a ground structure or other structure which supports the base member 120.

The gussets 126 are substantially triangular shaped. The gussets 126 extend upwardly from an upper surface of the base plate 122 and into respective edges defined by an intersection of adjacent side plates 130, which are discussed in more detail below. The gussets 126 are advantageously located on the base plate 122 to increase the stiffness of the base member 120 and facilitate load distribution when the jack pad 18 of the extension systems, e.g., extension system 14, engages the lifting structure.

The receiver member 124 is located substantially centrally with respect to the base plate 122. The receiver member 124 includes a plurality of side plates 130 extending upwardly from the upper surface of the base plate 122 to define a receiver opening 132. The receiver opening 132 is advantageously sized and shaped to receive the body 21 of coupler portion 20 of the extension system 14. In this manner, the extension system 14 can be interchangeably and removably coupled to the jacking device 12 and/or the jack stand 112. According to some aspects, a user may alternate use of the extension system 14 to construct a jack stand 112 and/or use as a jacking device 12. The user may lift the lifting structure using the jacking device 12 with an increased vertical range or stroke via the extension system 14. The user may concurrently or sequentially construct a jack stand 112 by coupling another extension system 14 to the base member 120, thus facilitating a more precise jack stand 112 that matches the vertical height of the jacking device 12. Further, as shown in FIGS. 1 and 2, the jacking system 10 and the jacking support system 110 are advantageously adapted to facilitate simple disassembly, thus providing jacking system 10 and jacking support system 110 that are compact and can easily be stored in kit bags or other storage space.

The receiver member 124 optionally includes a load dispersing ring 150. The load dispersing ring 150 has an annular body with an opening 152 to define an inner diameter of the load dispersing ring 150. The inner diameter of the load dispersing ring 150 is sized and shaped such that the ram extension 16 extends therethrough. More particularly, a lower surface of the load dispersing ring 150 abuts or makes substantial contact with corresponding upper surfaces of the side plates 130 of the receiver member 124. In this manner, the load dispersing ring 150 facilitates a substantially even load distribution of the lifting structure and also reduces, inhibits, or minimizes lateral movement.

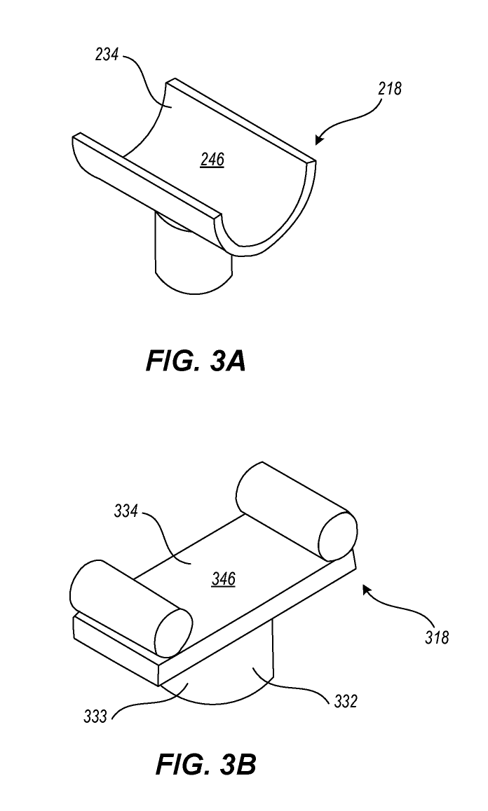

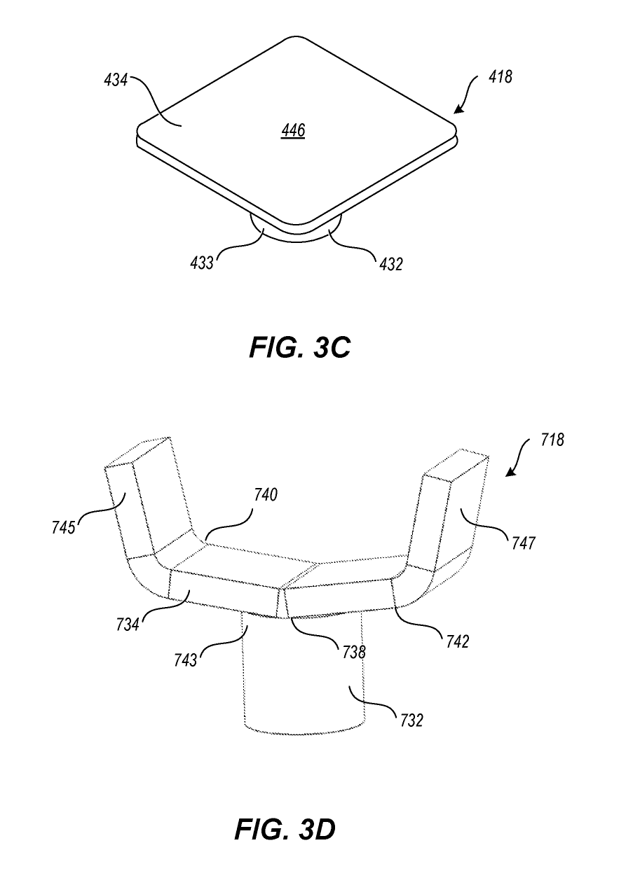

FIGS. 3A-3D illustrate jack pads 218, 318, 418, 718 according to various alternate embodiments. FIG. 3A illustrates a jack pad 218 that provides a variation in which an engagement portion 234 comprises a substantially semicircular shape. The engagement portion 234 can be configured such that an engagement surface 246 can abut or make substantial contact with a corresponding surface of a lifting structure, such as an axle, for example. FIG. 3B illustrates a jack pad 318, according to another embodiment. The jack pad 318 provides a variation in which an engagement portion 334 is substantially rectangular shaped. An engagement surface 346 is configured to be substantially parallel to the imaginary horizontal plane lying at a lower surface of a body 333 of a receiving portion 332. FIG. 3C illustrates a jack pad 418 according to yet another embodiment. The jack pad 418 provides a variation in which an engagement portion 434 is substantially square shaped. Again, an engagement surface 446 is configured to be substantially parallel to an imaginary horizontal plane lying at a lower surface of a body 433 of a receiving portion 432. FIG. 3D illustrates a jack pad 718, according to another embodiment. The jack pad 718 provides a variation in which an engagement portion 734 extends laterally from an end 738 of a receiving portion 732 in a substantially symmetrical manner about a central axis of the receiving portion 732 to define a first end 740 and an opposing second end 742. The engagement portion 734 extends angularly with respect to an imaginary horizontal plane lying at a lower surface of a body 743 of the receiving portion 732 to define a V-shaped engagement portion 734. The jack pad 718 further includes a first flange 745 which extends angularly from the first end 740 and a second flange 747 which extends angularly from the second end 742. The first and the second flanges 745, 747 are configured to reduce, mitigate, or avoid lateral movement of the lifting structure when the engagement portion 734 engages the lifting structure. In this manner, slipping of the lifting structure can be further reduced, mitigated, or inhibited.

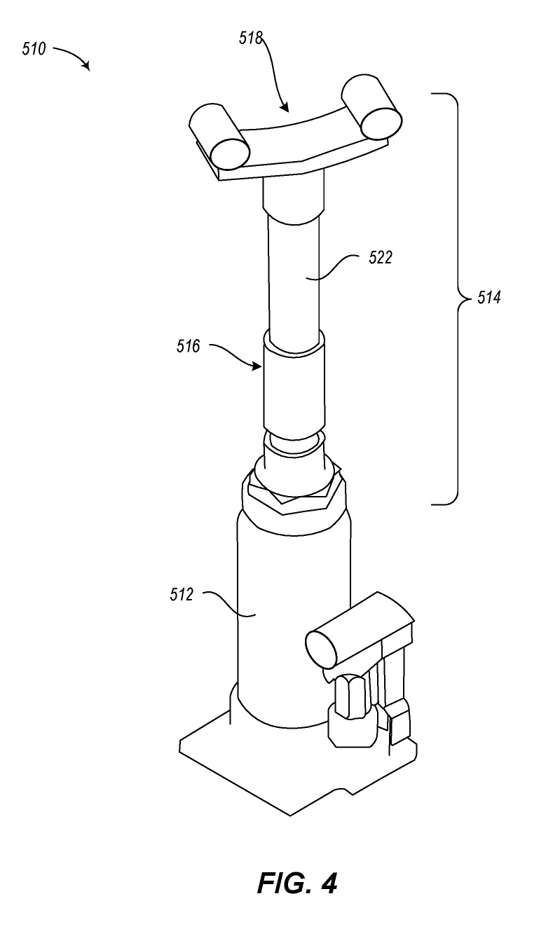

FIG. 4 illustrates a jacking system 510 according to another embodiment. The jacking system 510 provides a variation in which an extension system 514 includes an elongated ram extension 516. The elongated ram extension 516 includes an elongated ram portion 522 coupled to a jack pad 518, the elongated ram portion 522 being configured to have an elongated vertical length, such that a vertical range or stroke of the jacking device 512 or the jack stands (e.g., 112) can be extended. Further, as noted above, while the extension system 514 is illustrated being coupled to a jacking device 512, the extension system 514 can interchangeably be coupled to the various embodiments of the base member (e.g., 120) and/or ram extensions (e.g., 16).

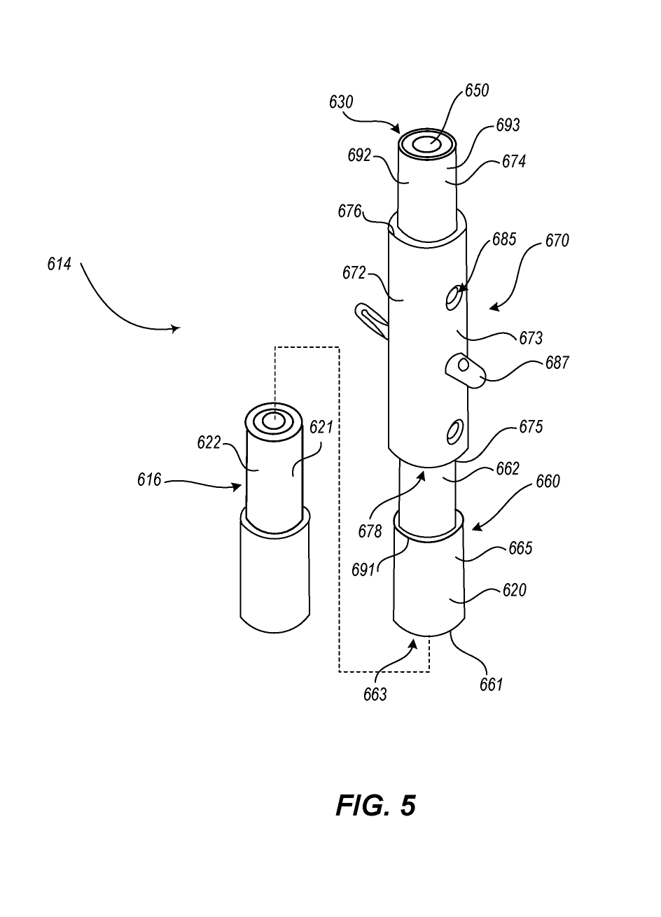

FIG. 5 illustrates an extension system 614 according to yet another embodiment. The extension system 614 provides a variation in which the extension system 614 includes an intermediate extension member 660 coupled to a ram extension 616, and an end extension member 670 coupled to the intermediate extension member 660. The intermediate extension member 660 includes a coupler member 620 and an elongated member 662. At a lower end 661, the coupler member 620 includes an opening 663 to define an inner diameter of a body 665 of the coupler member 620. The inner diameter of the body 665 of the coupler member 620 can be configured to removably receive therein a ram portion 622 of the ram extension 616. By way of example, an outer diameter of a body 621 of the ram portion 622 can be sized and shaped to have a smaller diameter than the inner diameter of the body 665 of the coupler member 620 such that when the coupler member 620 receives the ram extension 616, the coupler member 620 encloses a portion of the ram extension 616. The elongated member 662 extends from an upper end 691 of the coupler member 620. The elongated member 662 is configured to be removably received in the end extension member 670.

The end extension member 670 includes a center portion 672 and an end portion 674. The center portion 672 has an annular body 673 having a first end 675 and a second end 676. At its first end 675, the center portion 672 has an opening 678 to define an inner diameter of the center portion 672. The opening 678 is configured such that the elongated member 662 of the intermediate extension member 660 is removably received in the end extension member 670. By way of example, the inner diameter of the center portion 672 is sized and shaped to be larger than the outer diameter of a body of the elongated member 662, such that when the intermediate extension member 660 is received in the end extension member 670, the center portion 672 encloses a portion of the intermediate extension member 660.

The body 673 of the center portion 672 includes a plurality of spaced apart apertures 685. The apertures 685 are configured to removably receive therethrough a pin 687. More particularly, the apertures 685 are vertically spaced apart to facilitate vertical adjustment of the overall vertical lift or stroke of the jacking device (e.g., 12) or the jack stand (e.g., 112). By way of example, according to some aspects, the pin 687 can be inserted through the aperture 685 proximal to the intermediate extension member 660. As a shank of the pin 687 abuts or makes substantial contact with an outer surface of the elongated member 662, the vertical lift or stroke of the jacking device (e.g., 12) or the jack stand (e.g., 112) is increased. To adjust or lower the vertical lift or stroke, the pin 687 can be inserted through the aperture 685 located distal to the intermediate extension member 660. As the first end 675 of the extension member 670 is located proximal to the intermediate extension member 660, the overall vertical lift or stroke is thereby lowered.

A ram portion 692 extends from the second end 676 of the end extension member 670. The ram portion 692 has a substantially cylindrical body 693. At its distal end, the ram portion 692 includes a plurality of concentric rings 650 to define an engagement surface 630. The rings 650 are configured to facilitate gripping when the engagement surface 630 abuts or makes contact with a lifting structure, such as a vehicle, for example. Again, according to some aspects, the ram portion 692 may be adapted to directly engage the lifting structure, without other intervening structures, or in other aspects may include jack pads (e.g., 18, 218, 318, etc.) as discussed in more detail above to engage the lifting structure. Further, while the embodiment illustrated in FIG. 5 includes rings 650 to define the engaging surface 630, in other embodiments, the engaging surface 630 may include a waffle pattern, or other textured pattern to facilitate gripping, as discussed above.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A jacking system adapted to facilitate jacking of a lifting structure, the jacking system comprising:
an extension system interchangeably coupleable to a jacking device or a jack stand, the extension system including:
a coupler portion having an opening, the opening configured to removably couple the coupler portion to the jacking device or the jack stand; and
a ram portion configured to be engagingly coupleable to the lifting structure.

2. The jacking system of claim 1, further comprising:
a jack pad including:
a receiving portion configured to be removably coupled to the ram portion; and
an engagement portion having an engagement surface, the engagement surface configured to engage a corresponding surface of the lifting structure.

3. The jacking system of claim 2 wherein the engagement portion extends from a first lateral end to an opposing second lateral end to define the engagement surface which extends angularly from the first lateral end to the opposing second lateral end.

4. The jacking system of claim 2 wherein the engagement portion further comprises:
a pair of stops, each stop disposed on opposite ends of the engagement portion.

5. The jacking system of claim 1 wherein the jack stand includes a receiver member having a receiver opening, the receiver opening configured to receive therein the coupler portion of the extension system.

6. The jacking system of claim 1 wherein the extension system further comprises:
a load dispersing ring, the load dispersing ring configured to distribute load of the lifting structure.

7. The jacking system of claim 1 wherein the extension system further comprises:
an intermediate extension member coupled to the ram portion; and
an end extension member coupled to the intermediate extension member.

8. The jacking system of claim 7 wherein the end extension member includes a center portion and an end portion coupled to the center portion, the center portion including a plurality of vertically spaced apart apertures configured to receive therethrough a pin and facilitate vertical adjustment of the jacking system.

9. The jacking system of claim 7, further comprising:
a jack pad including:
a receiving portion configured to be removably coupled to the ram portion; and
an engagement portion having an engagement surface, the engagement surface configured to engage a corresponding surface of the lifting structure.

10. The jacking system of claim 9 wherein the engagement portion extends from a first lateral end to an opposing second lateral end to define the engagement surface which extends angularly from the first lateral end to the opposing second lateral end.

11. A method to facilitate lifting of a lifting structure, the method comprising:
coupling an extension system to a jacking device or a jack stand, such that the extension system is configured to interchangeably lift the lifting structure and support the lifting structure.

12. The method of claim 11, wherein the extension system includes a first extension system and a second extension system, the method further comprising:
coupling the first extension system to the jacking device; and
actuating the jacking device to lift the lifting structure.

13. The method of claim 12, further comprising:
coupling the second extension system to the jack stand.

14. The method of claim 13, further comprising:
adjusting the second extension system to support the lifting structure after actuating the jacking device to lift the lifting structure.

15. The method of claim 13, further comprising:
alternating between actuating the jacking device to lift the lifting structure and adjusting the second extension system to support the lifting structure.
